(19) United States
(12) Patent Application Publication
(10) Pub. No.: US 2011/0135257 A1
(43) Pub. Date: Jun. 9, 2011

(54) OPTICAL FIBER CONNECTOR

(75) Inventors: TAI-CHERNG YU, Tu-Cheng (TW); SHENG-JUNG YU, Tu-Cheng (TW); I-THUN LIN, Tu-Cheng (TW)

(73) Assignee: HON HAI PRECISION INDUSTRY CO., LTD., Tu-Cheng (TW)

(21) Appl. No.: 12/856,644

(22) Filed: Aug. 14, 2010

(30) Foreign Application Priority Data
Dec. 7, 2009 (CN) 200910311012.5

(51) Int. Cl. G02B 6/36

(52) U.S. Cl. 385/93

(57) ABSTRACT

An exemplary optical fiber connector includes a housing, and two lenses. The housing defines two first blind holes each configured for receiving an optical fiber. The two lenses are formed on the housing and each of the lenses is aligned with a corresponding first blind hole. The two second blind holes are defined on the housing and each of the second blind holes running through the housing to a corresponding first blind hole to allow adhesive to fill between the sidewall of the optical fiber and the inner wall of the blind hole.

### BACKGROUND

1. Technical Field

The present disclosure relates to optical fiber connectors.

2. Description of Related Art

Optical fiber connectors typically include a blind hole behind a lens. The blind hole is used to receive an optical fiber. The optical fiber inserted into the blind hole needs to be fixed by adhesive to avoid the optical fiber move in the blind hole. A typical method for adhering the optical fiber in the blind hole is to firstly insert the end of the optical fiber into the blind hole, and then to inject the adhesive at the opening of the blind hole while performing further insertion of the optical fiber into the blind hole to make the adhesive fill between the sidewall of the optical fiber and the inner wall of the blind hole, finally to insert the optical fiber further into the blind hole to accomplish the assemble process of the optical fiber. However, this method costs time and does not permit the adhesive to completely surround the sidewall of the optical fiber. This may result in the adhesion of the optical fiber in the blind hole as not strong enough and more likely make the central axis of the optical fiber deviate from the optical axis of the lens.

Therefore, an optical fiber connector which can overcome the above-mentioned problems is needed.

### BRIEF DESCRIPTION OF THE DRAWINGS

FIG. 1 is an isometric and schematic view of an optical fiber connector according to a first embodiment.

FIG. 2 is a sectional view taken along line II-II of the optical fiber connector of FIG. 1.

FIG. 3 is a cutaway view of an optical fiber connector, according to a second embodiment.

FIG. 4 is an enlarged view of the part IV of the optical fiber connector of FIG. 3.

FIG. 5 is a sectional view taken along line V-V of the optical fiber connector of FIG. 3.

FIG. 6 is a sectional view of an optical fiber connector, according to a third embodiment.

### DETAILED DESCRIPTION

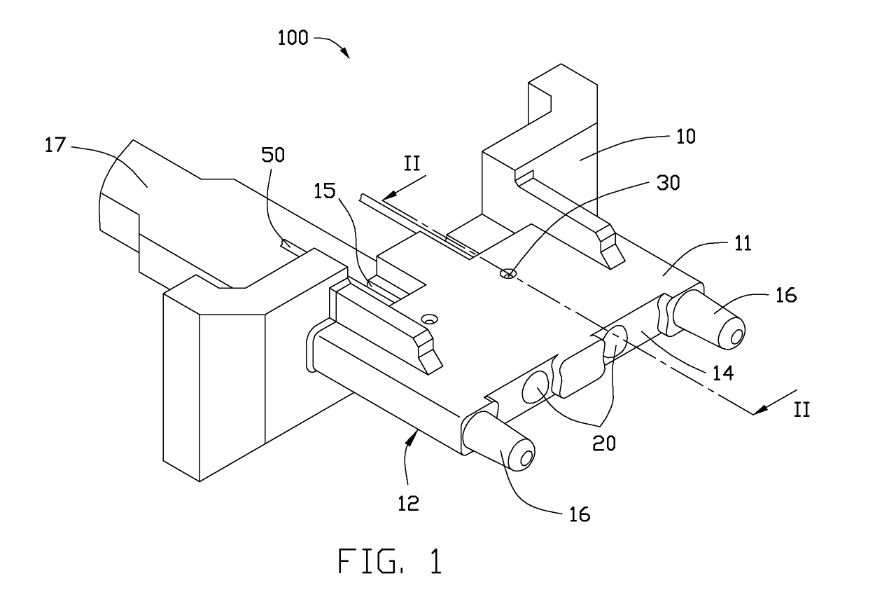

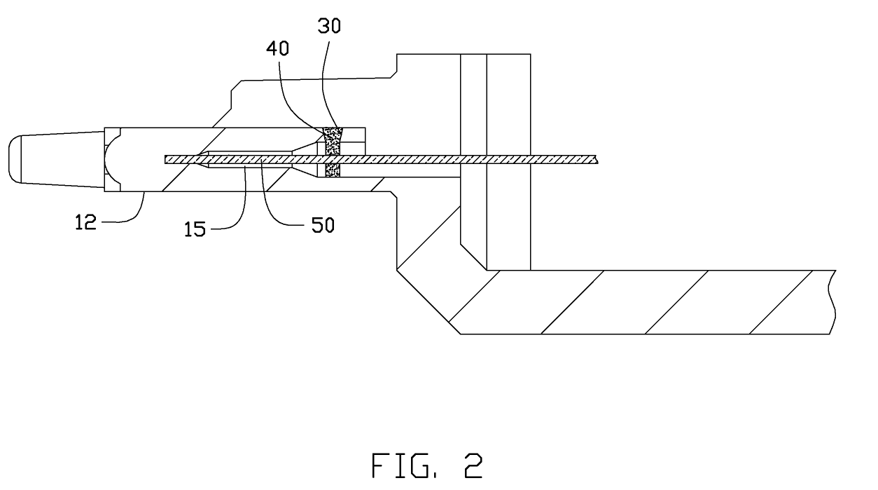

Referring to FIGS. 1 and 2, an optical fiber connector 100, according to a first embodiment, includes a housing 10 and two lenses 20.

The housing 10 includes a first surface 11, a second surface 12 opposite to the first surface 11, a third surface 13 and a fourth surface 14 opposite to the third surface 13. The first surface 11 is substantially parallel to the second surface 12. The third surface 13 and the fourth surface 14 respectively connect to the first surface 11 and the second surface 12.

The housing 10 defines two parallel first blind holes 15. Each of the first blind holes 15 extends from the third surface 13 to the fourth surface 14. The first blind holes 15 are configured for receiving optical fibers 50. In alternative embodiments, the number of the first blind holes 15 may be different and depends on a practical use of the optical fiber connector 100.

Each lens 20 is integrally formed with the housing 10 on the fourth surface 14 and optical coupled with a corresponding first blind hole 15. An optical axis of the lens 20 coincides with a central axis of the first blind hole 15. Two plugs 16 protrude from the fourth surface 14 and configured for fixing the optical fiber connector 100 while the optical fiber connector 100 is being used. The two lenses 20 are positioned between the plugs 16.

Corresponding to each of the first blind holes 15, the housing 10 defines a second blind hole 30. The second blind holes 30 run through the housing 10 from the first surface 11 to the corresponding first blind hole 15 and are in communication with the corresponding first blind hole 15. The second blind holes 30 are used to allow adhesive 40 to be injected into the first blind hole 15 and filled between the sidewall of the optical fiber 50 and the inner wall of the first blind hole 15 to fix the optical fiber 50. The central axis of each second blind hole 30 is substantially perpendicular to the central axis of the corresponding first blind hole 15. It is to be understood that in alternative embodiments, the central axis of each second blind hole 30 may be not perpendicular to the central axis of the corresponding first blind hole 15.

In the present embodiment, the second blind holes 30 are formed to be funnel-shaped to match an injection head for injecting the adhesive 40. In alternative embodiments, the second blind holes 30 may be formed to be other shapes such as cube-shaped, cylinder-shapes and so on. By configuring the second blind holes 30, the adhesive 40 can be quickly and easily injected into the first blind hole 15 and uniformly surrounded the sidewall of the optical fiber 50 after the optical fiber 50 is inserted into the first blind hole 15. Therefore, strong adhesion of the optical fiber 50 can be achieved. After injecting the adhesive 40, the second blind holes 30 may be filled by a filling member. In this embodiment, the filling member is the adhesive 40. It is to be understood that in alternative embodiments, the filling member may be other things such as the material the same as that of the housing 10.

The housing 10 further includes a grip 17 protruding from the third surface 13. When the optical fiber connector 100 is used, the optical fiber connector 100 can be assembled into an electronic device such as a notebook or a digital camera by griping the grip 17.

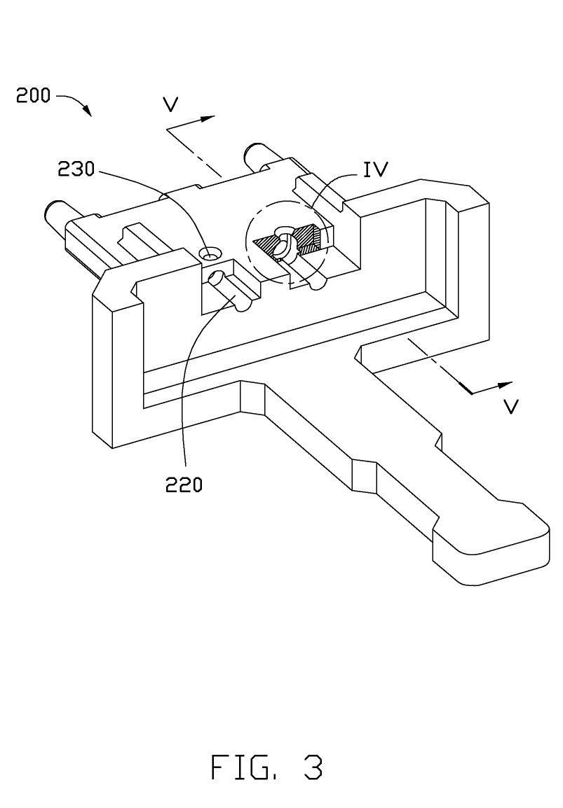

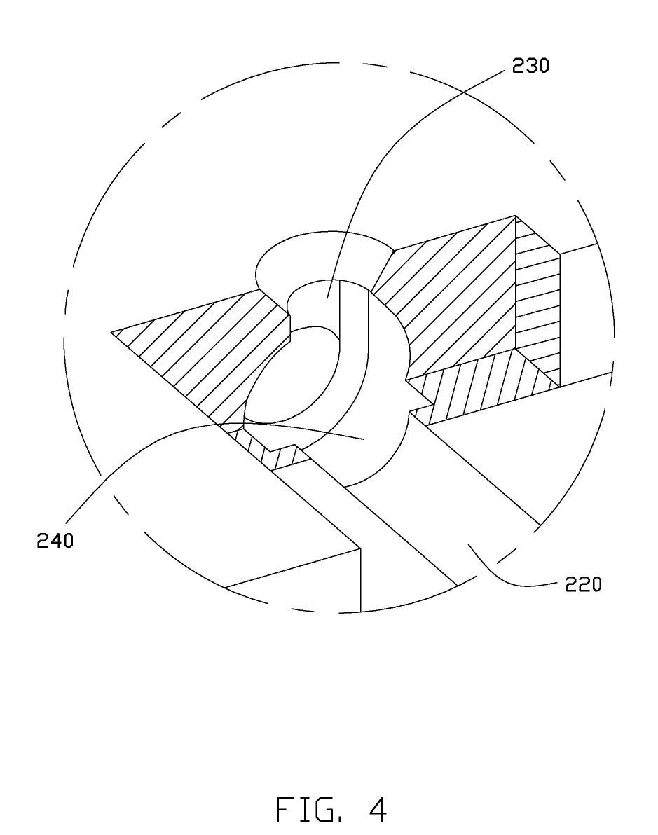

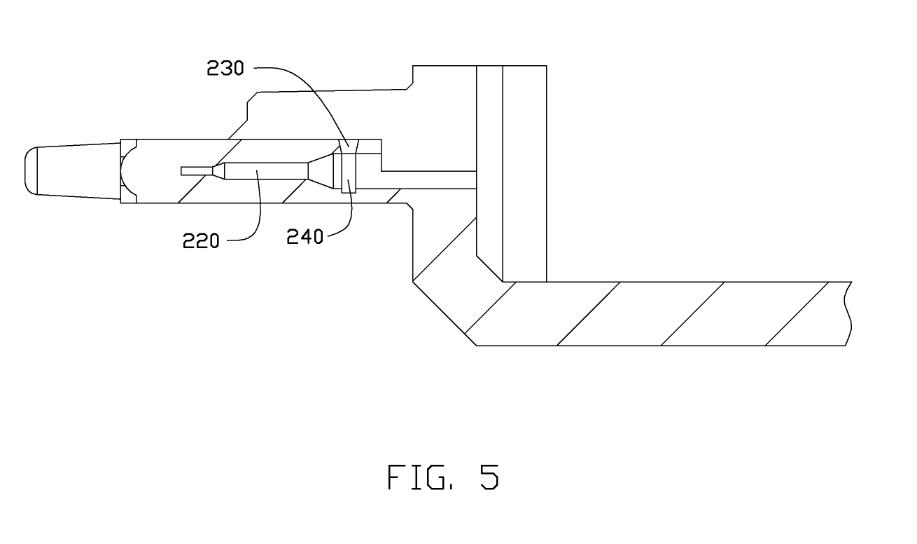

Referring to FIGS. 3, 4 and 5, an optical fiber connector 200, according to a second embodiment is shown. For clear describing the housing structure of the optical fiber connector 200, the drawing of the optical fiber connector 200 do not show the optical fiber. Comparing with the optical fiber connector 100 disclosed in the first embodiment, the optical fiber connector 200 further defines a U-shaped recess 240 in an inner sidewall in the first blind hole, spatially corresponding to the second blind hole 230. The U-shaped recess 240 is in communication with the second blind hole 230 and is configured for providing an extra space for the adhesive introduced from the second blind hole 230 to surround the optical fiber. It is to be understood that in alternative embodiments, the recess 240 may be formed to be other shapes.

Because of the U-shaped recess 240, more adhesive can be injected into the second blind hole 230 resulting in a more uniformly coated sidewall of the optical fiber, thus achieving a stronger adhesion of the optical fiber.

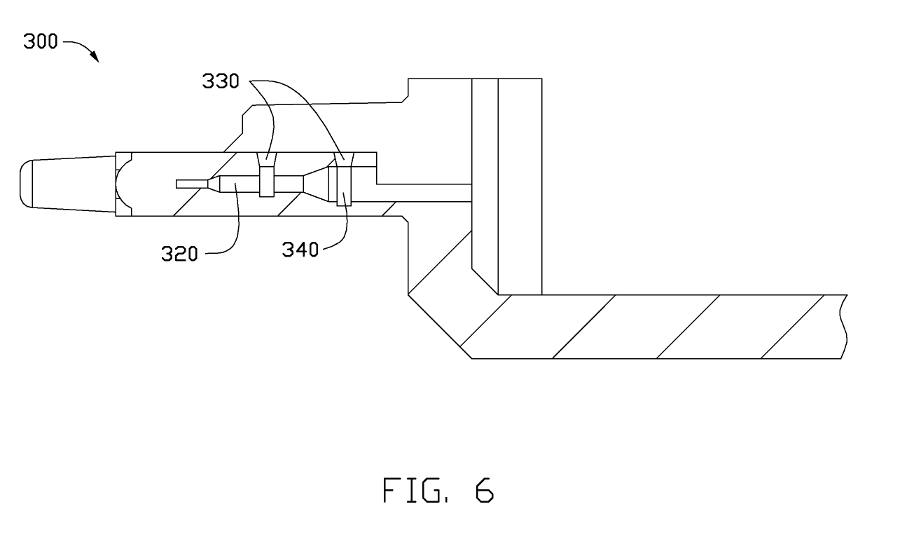

Referring to FIG. 6, in a third embodiment, corresponding with each first blind hole 320, the optical fiber connector 300 defines more second blind hole 330. Corresponding to each second blind hole 330, the optical fiber connector 300 includes a U-shaped recess 340 on the inner wall of the blind hole 320. The U-shaped recess 340 is in communication with the corresponding second blind hole 330. In alternative embodiments, the U-shaped recess 340 can be omitted.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An optical fiber connector, comprising:
an optical fiber;
a housing defining a first blind hole receiving the optical fiber and a second blind hole distinctly oriented from the first blind hole in communication with the first blind hole;
a lens formed in the housing and aligned with the first blind hole; and
an adhesive applied in the first blind hole for securing the optical fiber in the housing; the second blind hole is configured to introduce the adhesive into the first blind hole.

2. The optical fiber connector of claim 1, wherein the central axis of the second blind hole is substantially perpendicular to the central axis of the first blind hole.

3. The optical fiber connector of claim 1, wherein the lens is integrally formed with the housing.

4. The optical fiber connector of claim 1, wherein the housing further comprises a recess defined in an inner sidewall in the first blind hole, the recess spatially corresponding with the second blind hole and receiving the adhesive therein.

5. The optical fiber connector of claim 4, wherein the recess is substantially U-shaped.

6. The optical fiber connector of claim 1, wherein the second blind hole is substantially funnel-shaped.

7. The optical fiber connector of claim 1, further comprising a filling member filling the at least one second blind hole.

8. An optical fiber connector, comprising:
an optical fiber;
a housing defining a first blind hole receiving the optical fiber, a second blind hole in communication with the first blind hole, and a recess defined in an inner sidewall in the first blind hole, the second blind hole being substantially perpendicular to the first blind hole;
a lens formed in the housing and aligned with the first blind hole, the recess being proximate to the second blind hole and located at an opposite side of the second blind hole to the facing the lens; and
an adhesive received in the first blind hole and the recess for securing the optical fiber in the housing; the second blind hole configured to introduce the adhesive into the first blind hole.
